(19) United States
(12) Patent Application Publication
(10) Pub. No.: US 2004/0188543 A1
(43) Pub. Date: Sep. 30, 2004

(54) Constructional bolt with misting means

(76) Inventor: Seann Pavlik, Fort Lauderdale, FL (US)

Correspondence Address: NIXON & VANDERHYE, PC, 1100 N GLEBE ROAD, 8TH FLOOR, ARLINGTON, VA, 22201-4714, US

(21) Appl. No.: 10/632,895

(22) Filed: Aug. 4, 2003

Related U.S. Application Data
(63) Continuation-in-part of application No. 10/396,798, filed on Mar. 26, 2003.

(51) Int. Cl. B05B 15/00; B05B 17/00

(52) U.S. Cl. 239/289

(57) ABSTRACT

A constructional bolt, suitable for use in the securement of lighting fixtures and in other applications, includes an elongate body having a longitudinal internal channel including an open proximal end and a closed distal end, the distal end having a single orifice having a diameter in a range of about 0.008 inches (0.2 mm) about 0.020 inches (0.5 mm). Associated with the bolt is a pressurized water input to the proximal end of the channel at a pressure in a range of about 200 to about 1000 psi (1000 to 5000 cm Hg.). At such pressures, atomized droplets, in a range of about 5 to about 100 microns, are ejected by the orifice causing a flash evaporation, this producing a substantially instantaneous cooling of the ambient atmosphere by as much as 30 degrees F (16 degrees C.). A considerable number of such misting bolts may be provided to cool occupants within a defined space and in a system of landscape misting.

### REFERENCE TO RELATED APPLICATION

This case is a continuation-in-part of application Ser. No. 10/396,798, filed Mar. 26, 2003, entitled Water Misting and Cooling System for Marine Craft.

### BACKGROUND OF THE INVENTION

A. Area of Invention

The invention relates to a novel constructional bolt having integrated thereinto misting means. The bolt is usable as a part of a mist cooling system as well as other structural and functional aspects of a space to be cooled.

B. Prior Art

The prior art of misting devices relates mainly to the use of misting devices relates mainly to the use of misting nozzles as elements integrated within a larger system. Examples thereof may be found in U.S. Pat. No. 4,549,406 (1985) to Ebner et al; No. 5,722,596 (1998) to Dome; No. 6,175,969 (2001) to Edwards and No. 6,272,874 to Keeney. However, no art known to the inventor teaches a constructional or retaining element that is itself a misting means. It is to this end that the present invention is directed.

### SUMMARY OF THE INVENTION

A constructional bolt, suitable for use in the securement of lighting fixtures and in other applications, comprises an elongate body having a longitudinal internal channel including an open proximal end and a closed distal end, said distal end having a single orifice having a diameter in a range of about 0.008 inches (0.2 mm) to about 0.020 inches (0.5 mm). Associated with said bolt are means for furnishing a pressurized water input to said proximal end of said channel at a pressure in a range of about 200 to about 1000 psi (1000 to 5000 cm Hg.). At such pressures, atomized droplets, in a range of about 5 to about 100 microns, are ejected by said orifice causing a flash evaporation thereof, this producing a substantially instantaneous cooling of the ambient atmosphere by as much as 30 degrees F. (16 degrees C.). A considerable number of such misting bolts may be provided to cool occupants within a defined space.

It is thus an object of the present invention to provide a bolt usable in the securement of lighting and other cooling associated fixtures within a marine craft, and other areas, to effect the delivery of atomized particles of water vapor into open areas to thereby cool occupants by the flash evaporation of such droplets.

It is another object to provide an element, also having use in securement and constructional requirements, in which space therebeneath may be quickly cooled without any substantial wetting of the skin or surfaces thereabout.

It is a further object of the invention to a provide constructional bolt for lighting fixtures and the like that may be readily installed into a marine craft.

It is a yet further object to provide a bolt to enable a misting system which utilizes a fresh water source of the craft to pressurize water employed by the system.

The above and yet other objects and advantages of the invention will become apparent from the hereinafter set forth Brief Description of the Drawings, Detailed Description of the Invention and Claims appended herewith.

### BRIEF DESCRIPTION OF THE DRAWINGS

FIG. 1 is a perspective view of a lighting fixture equipped with a constructional bolt with misting means in accordance with the present invention.

FIG. 2 is an axial cross-sectional view taken along Line 2-2 of FIG. 1.

FIG. 3 is a bottom axial plan view of FIG. 2.

FIG. 4 is an exploded view of FIG. 1 showing the constituent elements thereof.

FIG. 5 is an operational view showing installation of a plurality of lighting fixtures which are each secured in place using the inventive constructional bolt.

FIG. 6 is a perspective view of a ceiling assembly which has been manufactured with lighting fixtures therein that may be used in association with the present invention.

FIG. 7 is a side elevational view showing application of the present invention to a yacht or cruise ship.

FIG. 8 is an enlarged portion of the aft area of the vessel of FIG. 7 showing the use of lighting fixtures and the misting system associated therewith, at multiple levels of the vessel.

FIG. 9 is a view, similar to that of FIG. 2, showing an alternate embodiment thereof.

FIG. 10 is a view, similar to that of FIG. 2, showing a further embodiment of the invention.

FIG. 11 is an axial cross-sectional view showing a slip-lock connection between the embodiment of FIG. 10 and a water conduit.

FIG. 12 is a view of the use of the structure of FIG. 11 as a landscape misting means.

### DETAILED DESCRIPTION OF THE INVENTION

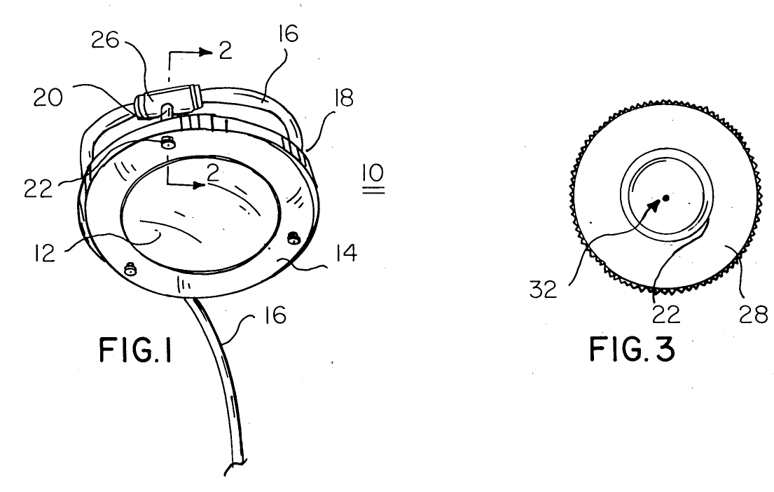

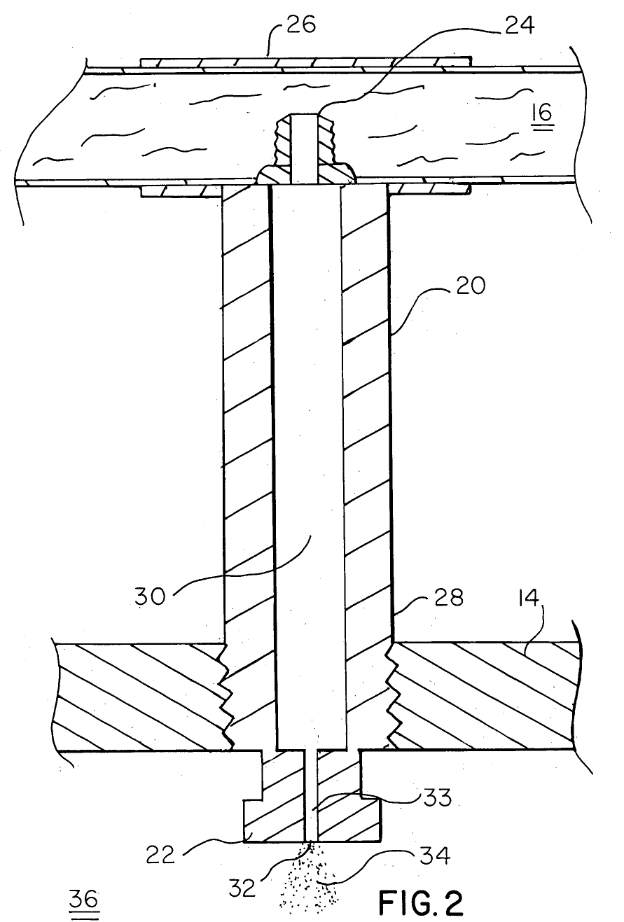

With reference to the perspective view of FIG. 1, there is shown a lighting fixture 10 inclusive of a light plate 12 and exterior annular bracket 14 which, in the prior art, is used to effect securement of the lighting fixture to a ceiling within the area to be illuminated. Further shown in FIG. 1 is a high pressure water conduit 16 which is positioned circumferentially about an upper surface 18 of said annular bracket 14. Also shown in FIG. 1 is a constructional bolt 20 having a distal end 22 and a proximal end 24 (see FIG. 2) which taps into said high pressure conduit 16 through a slip-lock fitting 26.

As may be more particularly noted with reference to said FIG. 2, said constructional bolt 20 comprises an elongate body 28 having a longitudinal internal channel 30 which includes said proximal end 24 which is open and said distal end 22 which is provided with an orifice 32 having a diameter in a range of about 0.008 inches (0.2 mm) to about 0.020 inches (0.5 mm). An axial input 33 to orifice 32 is approximately 8 millimeters.

It has been discovered that by furnishing a pressurized water input, using said conduit 16 and fitting 26, to said open proximal end 24 of the bolt 20, in a range of about 200 about 1000 psi (1000 to 5000 cm Hg), atomized water droplets 34 (see FIG. 2) having a diameter in the range of between about 5 and about 100 microns are ejected at high speed to thereby produce a flash evaporation within ambient atmosphere 36 such that, by such rapid withdrawal, the latent heat of evaporation (about 600 calories) of droplets 34, into the ambient atmosphere 36 in the vicinity thereof (about 2 meters) produces a cooling of as much as 30 degrees F (16 degrees C.) in zones misted thereby.

As may be appreciated, numerous applications of bolt 20 will become apparent to those of skill in the art, this including, without limitation, use within lighting fixtures, as is set forth below. In such application, bolt 20 passes through said annular bracket 14.

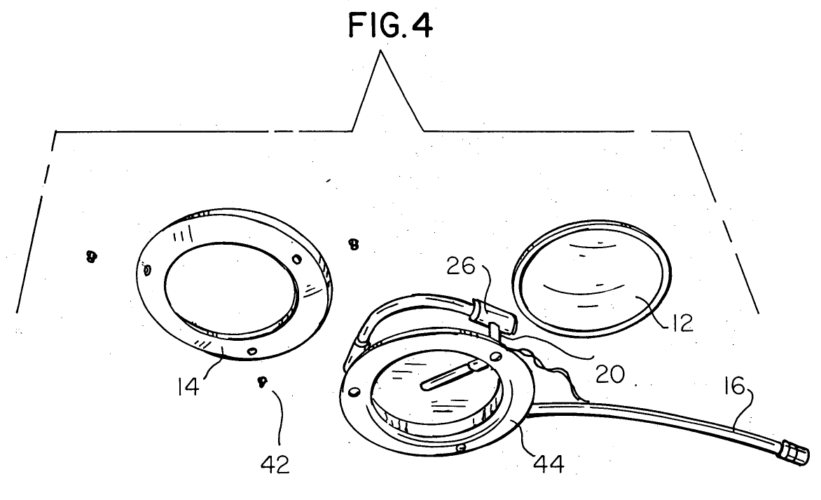

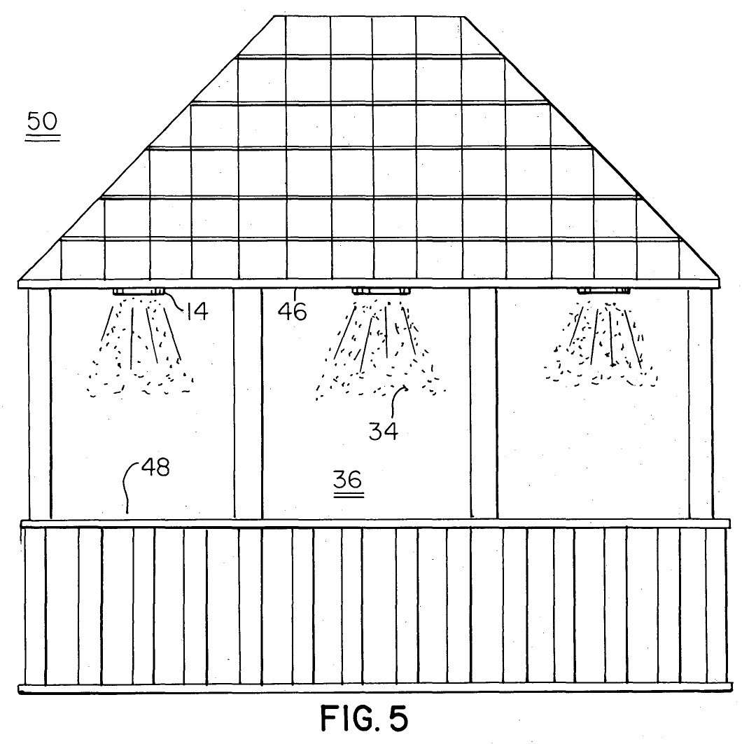

Shown in FIG. 4 is an exploded view of FIG. 1 wherein may be seen bolt 20, conduit 16, and slip-lock fitting 26. Also shown in FIG. 4 is light cover 12, annular bracket 14, and light fixture 44 to which exterior annular bracket is secured.

In FIG. 5 is shown an outdoor application of the instant invention in which misting droplets 34 project from a ceiling 46 of a porch 48 of a building 50. Thereby, FIG. 5 represents one of numerous outdoor applications of the inventive constructional bolt.

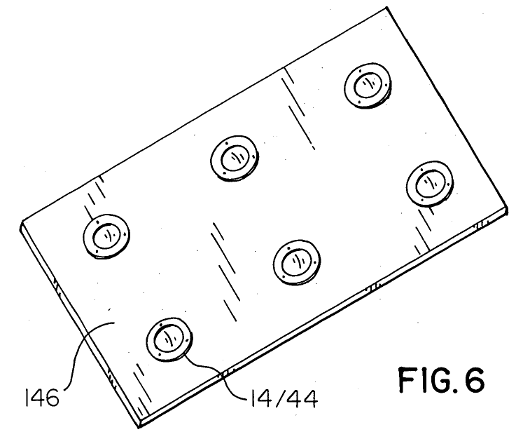

Shown in FIG. 6 is a ceiling 146 which may be manufactured with lighting bracket fixtures 14/44 already installed therein, this to accommodate lighting and misting situations where coverage of a larger area is desirable.

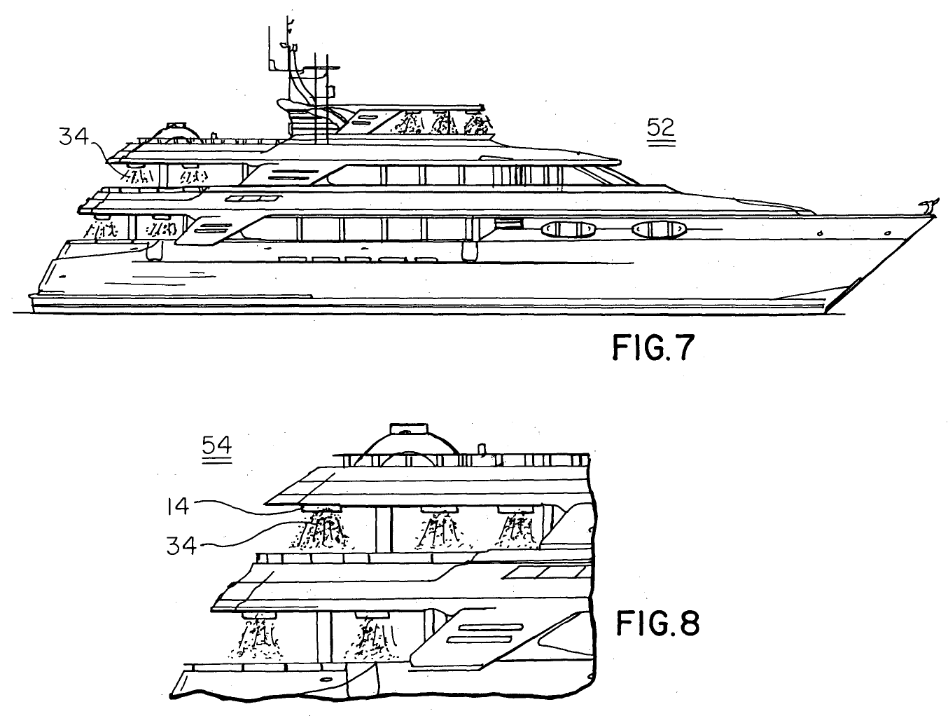

Shown in FIG. 7 is a side elevational view showing application of the above-described constructional bolt and associated lighting fixture to outdoor decks of a larger yacht or cruise ship 52. Shown in FIG. 8 is an enlarged portion of the aft area 54 of the vessel of FIG. 7 showing the use of the misting system in accordance with the present invention at multiple levels of the ship. In such applications, a suitable pressurized water input to conduit 16 is provided from a reservoir of the ship which is in fluid communication with a pump/compressor having maximum discharge pressure as high as 1500 psi. A suitable pump/compressor therefore has been found to be a Triplex direct drive plunger pump Module 2SF, which is sold by Cat Pumps, Minneapolis, MN 55449.

In the above and other applications of the present technology, conduit 16 is preferably provided with an unloader valve which is associated with said pump and with a flow gauge, by which the volumetric flow of the water into conduit 16 may be controlled.

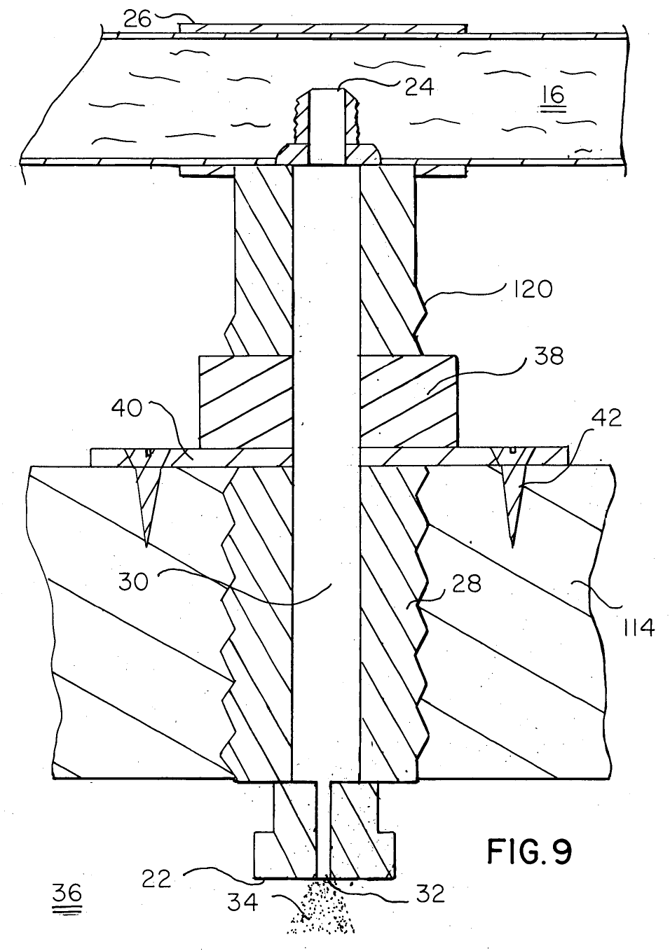

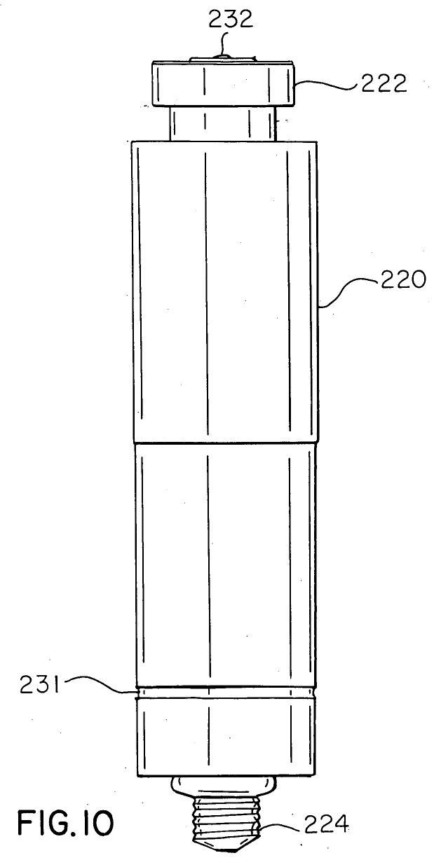

In FIG. 9 is shown an embodiment of a bolt 120 alternative to that of FIG. 2. Therein, bolt 120 is threaded and is secured to a wood surface 114 by means of a nut 38, washer 40 and screws 42. Other elements shown therein are described in FIG. 2 above.

From the above, it is to be appreciated that areas within a range of about two meters from each misting output of the constructional bolt described above may be employed to cool portions of boats or other outdoor structures, whether or not passengers or customers are in such area, thereby reducing the overall temperature of the craft or building. It has thereby been found that above-described flash evaporation of extremely fine droplets of water will cause a temperature drop of surrounding air of as much 30 degrees F. (16 degrees C.) within a matter of seconds, producing a refreshing effect to thus minimize the otherwise detrimental consequence of hot sun upon outdoor activities.

While it has been found that optimum conditions of such evaporative cooling exist when the ambient humidity is below 80% and ambient air is in a temperature range of 80 to 110 degrees F., it has been found that by chilling or refrigerating the supply of pressurized water, a significant degree of cooling may be accomplished even at higher humidity and temperatures.

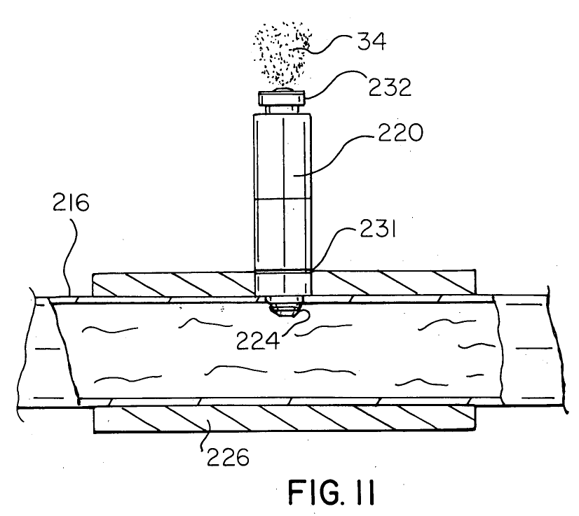

Shown in FIG. 10 is a further embodiment of the present inventive constructional bolt 220 with misting means associated therewith, the same including an elongate body, an open proximal end 224, and a distal end 22 which includes an orifice 232 having a diameter in a range of about 0.008 inches (0.2 mm) to about 0.020 inches (0.5 mm). The embodiment of FIG. 10 differs from that of FIG. 2 in its provision of a circumferential channel 231 about the lateral surface of body 222 near to the proximal end of the bolt. The function of circumferential channel 231 is, as is shown in FIG. 11, to snap-fit bolt 220 to a slip lock fitting 226 which surrounds a high pressure conduit 216 having a water pressure in a range of about 200 to about 1000 psi. An opening center tap of conduit 216 permits said snap-fit connection between fitting 226 and constructional bolt 220 so that open proximal end 224 of the bolt is provided with the source of pressurized water necessary to effect high pressure ejection of droplets 34 through said orifice 232.

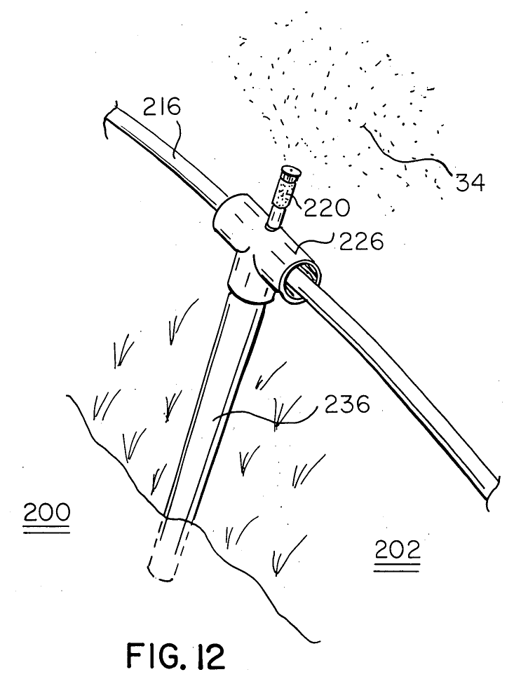

One application of the structure of FIG. 11 is shown in FIG. 12, namely, the use thereof in a landscape misting system. Therein, a vertical pipe 236 projects upwardly out of ground 200 from a water source (not shown) to provide the necessary pressurized water input to slip fit coupling 226 and, thereby, to said constructional bolt 220, thus effecting the emission of micron size droplets and the flash of evaporation thereof within the ambient atmosphere, thereby cooling the surrounding area as well as providing moisture to lawn 202. It is to be appreciated that arrangements of the type shown in FIG. 12 may cover an extended area and may have agricultural, as well, as landscaping, applications.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1-15. (Cancelled).

16. A light fixture comprising:
a light cover operatively connected to an annular bracket;
an elongated body having a longitudinal internal channel having a proximal end and a distal end;
a misting orifice provided adjacent said distal end;
a conduit for transporting water under pressure; and
said elongated body operatively connected to said conduit adjacent said proximal end and to said annular bracket adjacent said distal end, so that water to be misted is delivered to said orifice from said conduit by said elongated body, while the fixture also functions as a light fixture.

17. A light fixture as recited in claim 16 further comprising a plurality of said elongated bodies with misting orifices operatively connected to said conduit and said annular bracket.

18. A light fixture as recited in claim 16 wherein said orifice has a diameter of between about 0.2-0.5 mm.

19. A light fixture as recited in claim 18 wherein said conduit is connected to a source of water under a pressure of about 200-1000 psi.

20. A light fixture as recited in claim 19 further comprising a plurality of said elongated bodies with misting orifices operatively connected to said conduit and said annular bracket.

21. A light fixture as recited in claim 18 further comprising a plurality of said elongated bodies with misting orifices operatively connected to said conduit and said annular bracket.

22. A light fixture as recited in claim 16 wherein said elongated body is connected to said conduit through a coupling.

23. A light fixture as recited in claim 16 mounted within a ceiling of a marine vessel.

24. A ceiling panel comprising a plurality of light fixtures as recited in claim 16 installed therein.

25. A misting system comprising:
an elongated body having a longitudinal internal channel having a proximal end and a distal end;
an external screw-threading on said body between said proximal and distal ends;
a misting orifice provided adjacent said distal end;
a conduit for transporting water under pressure;
said elongated body operatively connected to said conduit adjacent said proximal end and to said annular bracket adjacent said distal end, so that water to be misted is delivered to said orifice from said conduit by said elongated body; and
a device which operatively connects said elongated body to a surface by said external screw-threading.

26. A system as recited in claim 25 wherein said device includes a nut.

27. A system as recited in claim 26 wherein said nut abuts a washer which is secured to said surface.

28. A system as recited in claim 26 wherein said orifice has a diameter of between about 0.2-0.5 mm.

29. A system as recited in claim 26 wherein said conduit is connected to a source of water under a pressure of about 200-1000 psi.

30. A system as recited in claim 25 wherein said orifice has a diameter of between about 0.2-0.5 mm.

31. A system as recited in claim 30 wherein said conduit is connected to a source of water under a pressure of about 200-1000 psi.

32. A system as recited in claim 25 mounted to a ceiling of a marine vessel.
